(19) United States
(12) Patent Application Publication
(10) Pub. No.: US 2018/0373577 A1
(43) Pub. Date: Dec. 27, 2018

(54) Method for Operating a Computer System, Computer Program With an Implementation of the Method, and Computer System Configured to Implement the Method

(71) Applicant: Siemens Aktiengesellschaft, München (DE)

(72) Inventors: Achim BANGERT, Speyer (DE); Uwe FRYE, Hagenbach (DE); Clemens SCHMITT, Erlangen (DE); Marco SCHOERGER, Bad Neustadt a.d. Saale (DE); Rahul SHARMA, Erlangen (DE); Johannes WEISS, Lisberg (DE)

(21) Appl. No.: 15/777,267

(22) PCT Filed: Nov. 18, 2016
(86) PCT No.: PCT/EP2016/078181

§ 371 Date: May 18, 2018

(30) Foreign Application Priority Data
Nov. 20, 2015 (DE) 10 2015 223 001.5

(51) Int. Cl. G06F 9/54

(52) U.S. Cl. CPC G06F 9/547

(57) ABSTRACT

A method for operating a computer system, a computer program for implementing the method and a computer system which executes the computer program, wherein at least one software application which functions as a host application and at least one software application which functions as a guest application are executed on the computer system, where at least one guest application offers at least one addressable software function, the host application uses at least one addressable software function of the at least one guest application based on a configuration, and where a position of the use of the at least one software function is specified on a display unit as part of the configuration.

### CROSS-REFERENCE TO RELATED APPLICATIONS

This is a U.S. national stage of application No. PCT/EP2016/078181 filed Nov. 18, 2016. Priority is claimed on German Application No. 102015223001.5 filed Nov. 20, 2015, the content of which is incorporated herein by reference in its entirety.

### BACKGROUND OF THE INVENTION

### 1. Field of the Invention

The invention relates to a method for operating a computer system and, more particularly, to a method for operating a computer system for controlling and/or monitoring a technical process, such as a power plant process for instance, where the computer system may also involve a distributed computer system. The invention also relates to a computer program with an implementation of the method as well as to a computer system configured to implement the method and the computer program.

### 2. Description of the Related Art

In contemporary computer systems, the situation often arises that a user would like to accomplish a task and requires multiple software applications for this purpose. Usually, each software application possesses its own user interface. The user must accordingly adjust to the operating philosophies of the respective application and transfer data from one application to the next. Mechanisms are available for such a transfer, such as those summarized under the keyword “copy & paste”. Additionally or alternatively, options such as an export of data of one application into a file and an import of the content of the file into another application may be used.

Regardless of the fact that this is sometimes complex and prone to errors, the user is in each case also confronted with the complete range of functions of the applications used. As software applications usually offer many more functions than the user actually requires to accomplish his respective task, locating and/or selecting each required function is often laborious, at least in terms of time, and associated with numerous operator actions for opening different menus or the like, for example. This leads to additional time spent, which is disruptive for the user. Overall, the overview across the different applications suffers.

### SUMMARY OF THE INVENTION

In view of the foregoing, one object of the present invention is therefore to provide a solution that enables a simple, task-focused access to at least one software application or a plurality of software applications.

This and other objects and advantages are achieved in accordance with the invention by a method for operating a computer system, in particular a distributed computer system, where at least one software application, which functions as a runtime environment and in the following is accordingly sometimes referred to as host application for short, executes on the computer system. In addition, at least one software application, which functions as a guest in relation to the host application and in the following is accordingly sometimes referred to as guest application for short, executes on the computer system. The or each guest application offers at least one addressable software function, such as an input field for representing and inputting data, or a text box for representing data. The fact that the guest application offers a software function, and in particular offers it as an addressable software function, means that the software function can be called up with the use of an address or reference from outside the guest application. In this manner, and based on a specified or specifiable configuration, the host application uses at least one addressable software function of the at least one guest application. The configuration is preferably specified in text via a descriptive language with a specific syntax, such as XML. Here, use of the addressable software function is understood to be a call-up of the software function by the host application or a call-up of the software function initiated by the host application. When executing the host application, as part of an execution of a respective software function resulting due to such a call-up, there is accordingly a display of a text box, for example, as would otherwise be output by the guest application. By the display of the text box occurring via the host application, the user does not perceive the execution of the guest application at all and receives the display within a user interface of the host application. As part of the configuration processed by the host application, a position of the output text box, in particular a position and a dimension of the text box, on a display device or a display unit or within a user interface represented by the host application can be specified. In general, a position and/or dimension of an output of a respectively used addressable software function of a guest application can be specified via the configuration. This specification is accordingly referred to as the specification of the position of the use of the respective software function for short.

The advantage of the solution proposed here consists in that the user perceives the task of the host application and the user interface thereof and that a software application running “underneath” in a sense, i.e., a guest application, does not make an appearance for the user. The host application thus enables access to the software application running as guest in each case, which can be specified via the configuration, and equally a simultaneous access to a plurality of software applications running as guest. As the respective access to a guest application or a plurality of guest applications can be specified via the respective configuration, what ultimately appears as the output of the host application according to the configuration is precisely that which is necessary to handle the respective task of the user. It should be understood a prerequisite for this is that, as part of a previous analysis, it had been ascertained which software functions are actually required and that a corresponding configuration had been compiled. Concentrating the output occurring via the host application on that which the user requires for his respective task in this way is understood as a task-focused output and task-focused access to at least one software application (guest application) or a plurality of software applications.

Furthermore, as part of the configuration, i.e., when compiling the configuration, at least one software object is defined. As part of defining the at least one software object, it is linked with an addressable software function of a guest application. As part of a processing of the configuration by the host application, a call-up of the software function linked with the software object results due to this definition of the software object. In turn, due to the call-up of the software function, an output of the software function results on the display unit, namely the display unit actuated by the host application. The definition of software objects as part of the configuration allows their use in the form of a computer program which can be executed by the host application and furthermore, for example, a data exchange between individual guest applications.

In one embodiment of the method, at least a first and a second guest application executes on the computer system, the at least two guest applications each offer at least one addressable software function in the manner outlined above, the host application utilizes at least one addressable software function based on a configuration in each case, a position at which the at least two software functions is utilized on a display device or a display unit is specified as part of the configuration and a data exchange between the at least two software functions or the respective guest applications occurs via the host application.

The advantage of this embodiment of the method consists in that the user may not only use the respective at least one software function of two otherwise independent guest applications simultaneously via the host application, and any possible outputs are displayed together via the host application, but rather that a data exchange occurs between the software functions or the respective guest applications that offer the software functions. Here, the data exchange occurs automatically via the host application, i.e., without specific intervention by the user. Accordingly, for a data exchange between individual software applications the user no longer has to use a clipboard (copy & paste) or export data from a first software application into a file, in order to then be able to import it into a second software application. The host application brings about the data exchange in a sense “in the background” and for this purpose based on a use of addressable software functions made available by the respective guest application. A further advantage consists in guest applications being able to be operated together via the host application, the guest applications not originally being provided for interaction and consequently also having no “knowledge” of another guest application in each case. The host application unifies guest applications, in a sense, under a common roof, and also enables the subsequent introduction of new functions at any time.

In yet another embodiment of the method, at startup or due to a corresponding user action the host application loads a configuration and uses the loaded configuration until another configuration is loaded. Loading a new configuration results in use of another guest application or software function or other guest applications or software functions or another use of one or more guest applications or software functions.

Each configuration thus leads to a unique user interface corresponding to the configuration and, by using a suitable configuration in each case, a user can select the user interface most appropriate for his respective task. By modifying the configuration or by using another configuration, the system consisting of host application and at least one guest application is more flexible and can be adjusted at runtime of the computer system and also at runtime of the host and guest application or of the respective guest application, without the need to recompile the host or guest application, for instance. Here, all of the tools and functions made available by the or each guest application can be used by the user and recombined with regard to an optimal workflow for the respective task.

The method or the method with one or more of the embodiments outlined above is implemented in software. The invention is thus firstly also a computer program with program code instructions executable by a computer and, secondly, a storage medium with such a computer program, i.e., a computer program product with program code means, and finally a computer system of the type mentioned in the introduction with at least one computer, in the memory of which such a computer program is loaded or loadable as a way to implement the method and its embodiments.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

An exemplary embodiment of the invention is explained in more detail below with reference to the drawing. Objects or elements corresponding to one another are labeled with the same reference characters in all of the figures, in which:

FIG. 1 shows a distributed computer system in accordance with the invention;

FIG. 2 shows a representation illustrating a call-up of a software function of a guest application via a hierarchically higher-level host application and an allocation of each individual display region of an output unit to a software function, such that outputs of the software function occur there in accordance with the invention;

FIG. 3 shows a representation illustrating a configuration used by the host application in accordance with the invention;

FIG. 4 shows a further representation illustrating a configuration used by the host application in accordance with the invention; and

FIG. 5 is a flowchart of the method in accordance with the invention.

### DETAILED DESCRIPTION OF THE EXEMPLARY EMBODIMENTS

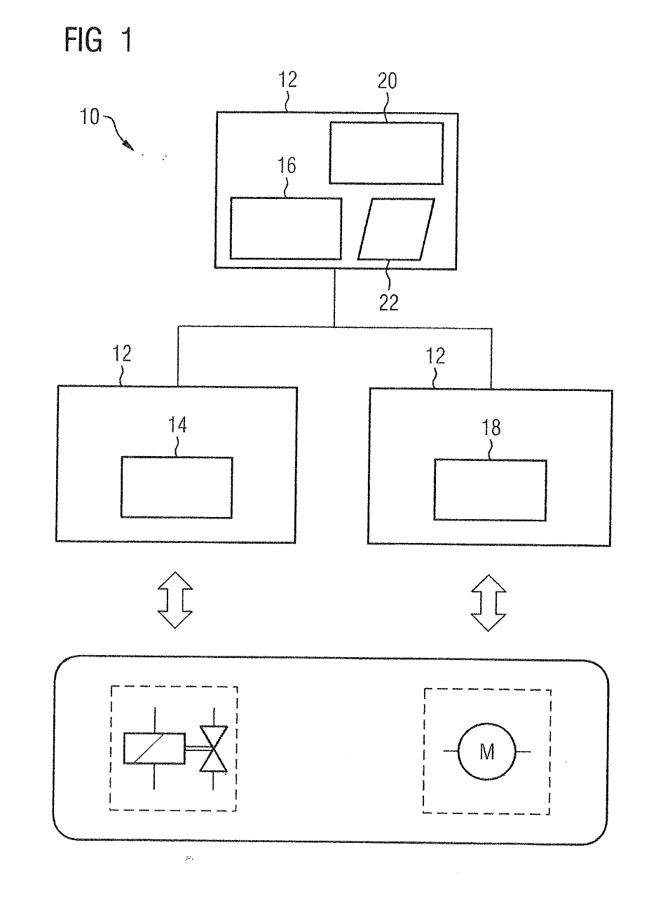

The representation in FIG. 1 shows a distributed computer system 10, consisting of a plurality of communicatively interconnected computers 12, in a schematically simplified manner. The communicative connection may exist in the form of a local network, a regional network or even over the Internet. The innovation presented here, however, does not necessitate a distributed computer system 10. Rather, a single computer 12 is sufficient in principle. This single computer 12 is then regarded as the computer system 10. The subsequent description continues based on a distributed computer system 10 according to the representation in FIG. 1. This is not to be interpreted as a limitation. Rather, it should always be understood that it is possible for a single computer 12 to function as a computer system 10 in the context of the following description.

A plurality of software applications 14, 16, 18 are executed via the computer system 10, such as to control a power plant, via a processing unit in the form of or as a type of microprocessor, which software applications for this purpose are loaded into a respective memory in the usual manner. The computer system 10 thus functions as a way to control and/or monitor a technical process not shown in further detail in FIG. 1, such as a process for generating energy in a power plant.

A software application 14 for diagnosing a combustion procedure in a boiler (combustion diagnosis), a software application 16 for monitoring vibrations of a turbine (vibration monitoring), a software application 18 for detecting and monitoring statistical data (statistics module) and soon should be mentioned as exemplary software applications used in the context of controlling a power plant.

A user who requires the software applications 14, 16, 18 to accomplish a specific task has in practice previously been faced with the problem outlined in the introduction of the data output by the software applications 14, 16, 18 often not being able to be viewed at the same time, access to individual pieces of information or functions of a software application 14, 16, 18 being hidden deep inside a menu structure of the respective software applications 14, 16, 18 and/or an exchange of data between two different software applications 14, 16, 18 not being readily possible.

The approach proposed here provides an additional software application, which lies hierarchically above the or each software application 14, 16, 18 which the user requires to accomplish his respective task. This specific software application is sometimes accordingly referred to in the following as a host application 20, and the or each software application 14, 16, 18 lying hierarchically below is accordingly referred to as guest application 14, 16, 18. The host application 20 is a computer program and represents an implementation of the approach proposed, here. Accordingly, the host application 20 involves a computer program representing an implementation of the approach proposed, here.

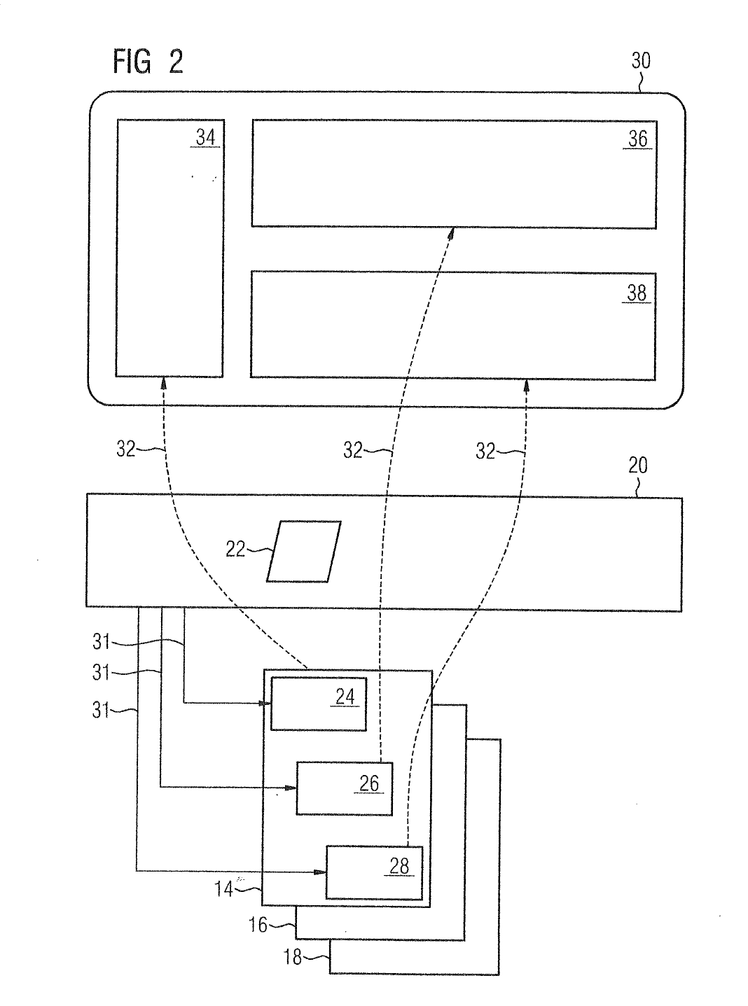

For the further description, the simplest case is primarily assumed, i.e., a single software application 14, 16, 18 functions as the guest application 14, 16, 18. A task-focused access to this guest application 14, 16, 18 via the host application 20 is based on a configuration 22. It is determined via the configuration 22 which software function 24, 26, 28 (FIG. 2) or which software functions 24, 26, 28 are accessed via the host application 20, i.e., which software function 24, 26, 28 or which software functions 24, 26, 28 the host application 20 uses. Software functions 24, 26, 28 of a guest application 14, 16, 18 that can be used by the host application 20 can be called-up from outside the respective guest application 14, 16, 18. For this purpose, an address that can be used for such an external call-up, or another reference, such as an identifier, is made available in a manner which in principle is known, such as in the context of an Application Programming Interface (API). At least one software object is defined as part of the configuration. This is linked with an addressable software function 24, 26, 28 of a guest application 14, 16, 18 as part of the definition of the software object. As part of a processing of the configuration 22 by the host application 20, due to the definition and the linking with the software function 24, 26, 28, this results in a call-up of the respective software function 24, 26, 28.

Due to this addressability, the host application 20 can call up individual software functions 24, 26, 28 of a guest application 14, 16, 18 which is in principle independent of the host application 20, and a representation of on-screen outputs of the guest application 14, 16, 18 occurs on a display unit 30 of the host application 20 in display regions 34, 36, 38 (FIG. 2), of which the position or position and dimension or position, dimension and appearance (frame, color, etc.) is determined via the configuration 22. The on-screen output of each software function 24, 26, 28 called up occurs according to the respective functionality thereof. Thus, if the software function 24, 26, 28 outputs statistical data in the form of a table if the guest application 14, 16, 18 is executed separately, then an output of the statistical data in such a manner also occurs if the software function 24, 26, 28 is called up via the host application 20. A display unit 30 of the host application 20 is understood in this context to be the display unit of the computer 12 upon which the host application 20 is executed.

The representation in FIG. 2 shows in this regard, viewed from top to bottom, firstly a schematically simplified view of the display unit 30 of the computer 12 upon which the software application 20 functioning as host application 20 is executed, followed by the host application 20 in the center and finally below a guest application 14, 16, 18 used by the host application 20 and software functions 24, 26, 28 used thereby in turn. The call-up of a software function 24, 26, 28 by the host application 20 due to the addressability thereof is to be illustrated via the arrow 31. The display regions 34, 36, 38 in which the on-screen output of the individual software functions 24, 26, 28 occurs are to be illustrated via the arrow 32.

The schematically simplified representation in FIG. 2 makes it clear that it can be determined via the configuration 22 used by the host application 20 where the on-screen output of a software function 24, 26 used by the host application 20 occurs. In a sense, the host application 20 thus creates a new and, most of all, configurable user interface for a guest application 14, 16, 18 used. The representation in FIG. 2 already shows that it is irrelevant in this context whether the host application 20 uses precisely one software application 14, 16, 18 or a plurality of software applications 14, 16, 18 and the software functions 24, 26, 28 thereof.

The underlying configuration 22 is present in the form of a file with XML code, for example, which evaluates the host application 20. By adjusting the configuration 22, it becomes possible to adjust each resultant user interface. For example, the position and/or the dimension of individual display regions 34, 36, 38 can be changed. Additionally or alternatively, as part of an adjustment of the configuration 22, individual display regions 34, 36, 38 may be dispensed with or new display regions 34, 36, 38 may be added. By using different configurations 22 in each case, i.e., corresponding files, for example, different user interfaces arise, such that the user obtains a display of a task-focused user interface appropriate for the respective task via the host application 20 by using a configuration 22 suitable for his respective task. Each resultant user interface enables the user to obtain a display of precisely that data which he requires for his task. By presenting the data in a sequence resulting in a manner corresponding to the placement of the display regions 34, 36, 38, it can be ensured that the representation occurs in a manner that is as clear as possible and/or can be comprehended as quickly as possible.

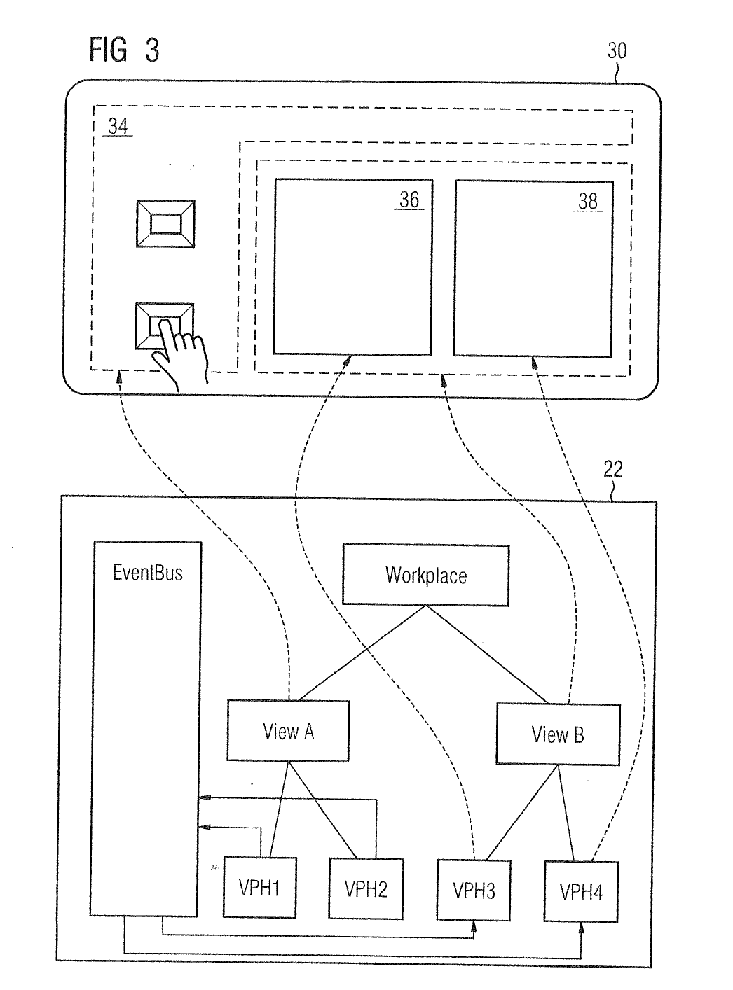

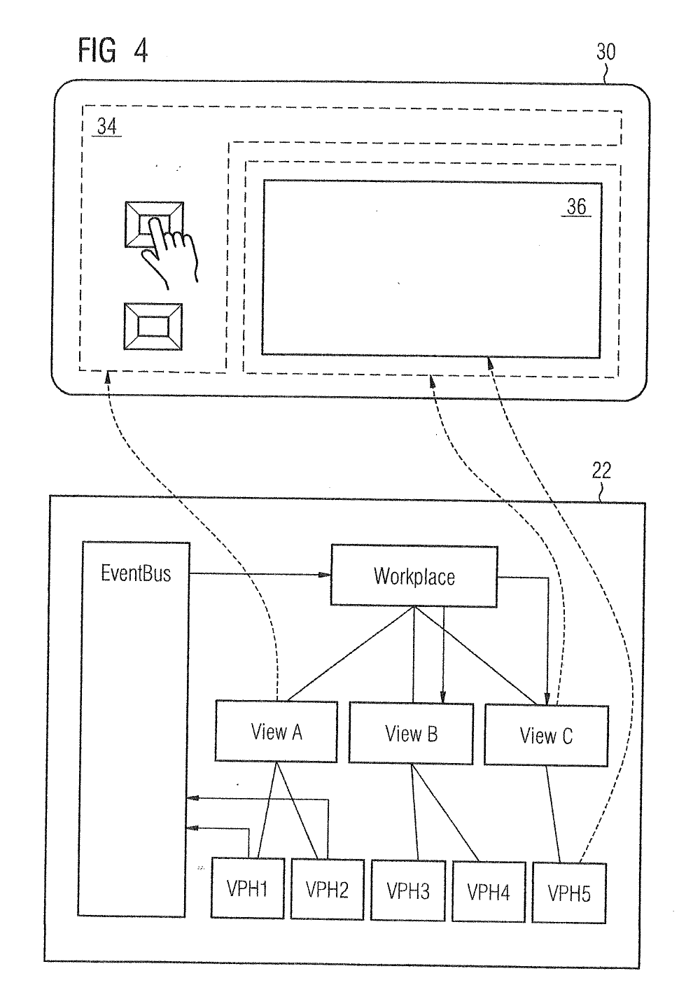

The task-focused display/task-focused user interface resulting according to the approach proposed does not need to be static. To this end, reference is made to the schematically simplified representations in FIG. 3 and FIG. 4. Both representations show in the upper region, in each case, a user interface on a display unit 30 of the host application 20 and in the lower region a configuration 22 of the software application 20 functioning as the host application 20. In practice, the configuration 22 is specified in an XML code, for example. For graphical representation of the configuration 22, instead of such a code or a similar code, functional blocks are shown that each represent the respective individual software objects. The user interface resulting due to the respective configuration 22 is represented on an uppermost hierarchy level by a software object referred to as “Workplace” in the representations. Within the user interface, there are one or more display regions (“View A”, “View B”, etc.) and in each display region one or more so-called view part holders (“VPH1”, “VPH2”, “VPH3”, “VPH4”, etc.). In the context of a per se known, so-called observer pattern, the option exists of registering individual software objects defined as part of the configuration 22 at a so-called event bus (“EventBus”). This registration occurs via a corresponding encoding of the respective software object as part of the configuration 22 and the registration determines an action which should occur in case of an event occurring in relation to the respective software object. Here, for example, an event is a mouse click on an on-screen representation associated with the software object, such as a mouse click on the on-screen representation of a button.

In the example shown in FIG. 3, the arrows from and to the software objects there are intended to illustrate the registration of individual software objects (in this case “VPH1” and “VPH2”) at the event bus and a linking of the software objects with other software objects (in this case “VPH3” and “VPH4”) defined thereby. When a host application 20 using a corresponding configuration 22 is executed, this registration and linking leads to a representation occurring in a display region 36 allocated to the software object “VPH3”, when a button represented within the user interface of the host application 20 due to the software object “VPH1” is clicked upon, and a representation occurring in a display region 38 allocated to the software object “VPH4”, when a button represented due to the software object “VPH2” is clicked upon. Here, the representation occurring in the respective display region 36, 38 can itself be designated by the definition of the respectively underlying software object “VPH3” or “VPH4” and can be determined as part of a corresponding encoding of the configuration 22. A corresponding encoding of such software objects causes an output of a software function 24, 26, 28 that can be called up via the host application 20 in individual display regions 36, 38, for example, as has been explained previously based on the representation in FIG. 2.

It should be understood the example shown in FIG. 3 can be continued as desired based on the principle explained, such that each resultant user interface of the host application 20 comprises a larger number of button representations, for example, and with a click on each of the button representations a representation of different data can be called up, where the data displayed in each case originates from a guest application 14, 16, 18 on a lower hierarchical level than the host application 20, in particular from a guest application 14, 16, 18 from a group having a plurality of guest applications 14, 16, 18.

In the example shown in FIG. 4, the arrows to the event bus there should illustrate as before that the respective software objects (here “VPH1” and “VPH2”) and actions linked to them are registered at the event bus. In the case of a mouse click on a corresponding representation or a selection of such a representation via the mouse or similar so-called events, however, the registration here leads to a signal to the software object (“Workplace”) representing the entire user interface, which leads to subsequent signals to two software objects (“View B” and “View C”), which each represent individual display regions. These subsequent signals in turn cause a status of the software objects to change. A previously visible software object (“View B”) becomes invisible (the software object is unloaded as part of the user interface) and a previously invisible software object (“View C”) becomes visible, by it being loaded as an additional part or as a part of the user interface replacing another software object. The result is shown in the upper region of the representation in FIG. 4 and in the example shown leads to an enlarged display region 36 superseding two display regions 36, 38, in which, for example, the representation of a previously not called-up software function 24, 26, 28 of one of the software applications 14, 16, 18 functioning as guest application 14, 16, 18 is output.

Naturally, the complexity of a user interface resulting via the approach proposed here can in principle increase as desired. The respective representation types and representation options are only limited by the range of functions of the software application 20 functioning as host application 20. A Java application, which processes a file with XML code as the configuration 22, comes into consideration as host application 20, for example. With a Java application as host application 20, the or each guest application 14, 16, 18 likewise involves a Java application. More generally, in the approach proposed here, the host application 20 and the or each guest application 14, 16, 18 are based on the same technology.

Here, the proposed approach is not, however, limited to a task-focused and possibly dynamically modifiable display of data. With the host application 20 and the underlying configuration 22, an exchange of data between two or more guest applications 14, 16, 18 used by the host application 20 is also possible.

A transmission of data from one guest application 14, 16, 18 to another guest application 14, 16,18 occurs, for example, in the form of an object of a conventional object type or in the form of an object of a specific variant of an object type. For transmission of data in the form of an object of a conventional object or data type, an object of the “string” type or a plurality of such objects come into consideration. In this way, both text and also natural or real numbers converted into a sequence of characters (string) can be transmitted. Transferring data in the form of an object of a specific object or data type is then possible if both software applications 14, 16, 18 involved in the data exchange support the respective object or data type.

Additionally or alternatively, a transmission of data from one guest application 14, 16, 18 to another guest application 14, 16,18 or to a further software application, referred to as external application to differentiate it from a guest application 14, 16,18, is possible, e.g., via conventional network interfaces, such as network interfaces as known for CORBA, Web Services, OPC or DCOM. The data exchange with an external application enables the transmission of any desired data in any desired manner, namely from the guest application 14, 16, 18 as part of a corresponding programming of specified data there, to a server or a cloud.

Although the invention has been illustrated and described in detail on the basis of the exemplary embodiment, the invention is not limited by the disclosed example or examples and other variations can be derived herefrom by the person skilled in the art, without departing from the scope of protection of the invention. Individual significant aspects of the description set forth here can thus be briefly summarized as follows: Specified are a method for operating a computer system 10, a computer program 20 with an implementation of the method, and a computer system 10 configured to perform the method. Running on the computer system 10 is at least one software application functioning as host application 20 and at least one software application functioning as guest application 14, 16, 18, where the or each guest application 14, 16, 18 offers at least one addressable software function 24, 26, 28. The host application 20, based on a configuration 22, utilizes at least one addressable software function 24, 26, 28 of the at least one guest application 14, 16, 18, where as part of the configuration 22, the position at which the at least one software function 24, 26, 28 is utilized on a display unit 30 is specified.

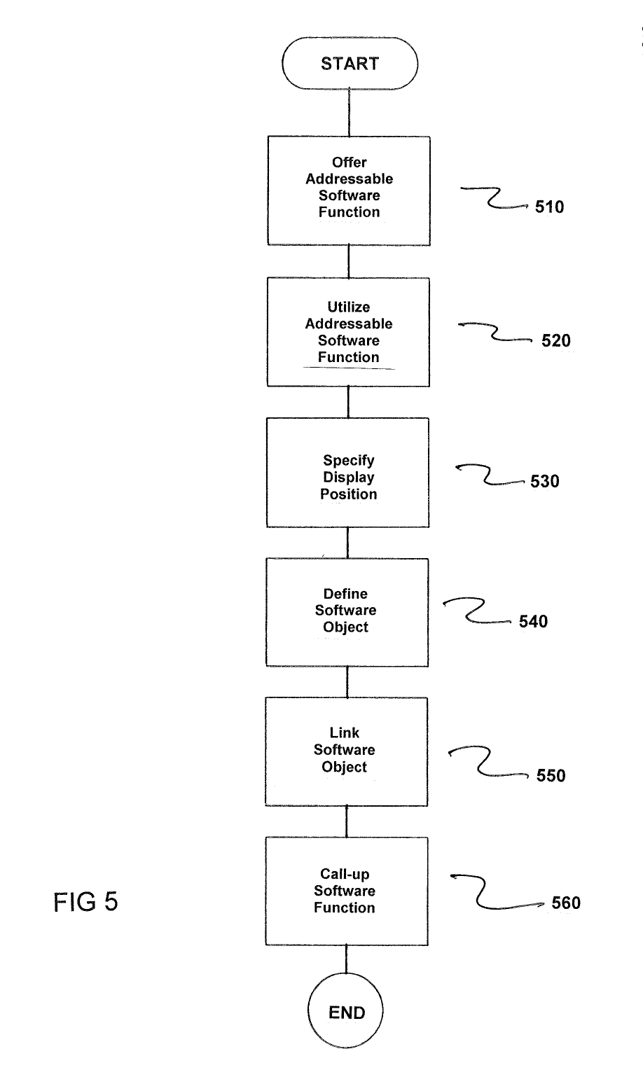

FIG. 5 is a flowchart of a method for operating a computer system 10 upon which at least one software application functioning as host application 20 and at least one software application functioning as a guest application 14, 16, 18 are executed. The method comprises offering at least one addressable software function 24, 26, 28 by at least guest application 14, 16, 18, as indicated in step 510.

Next, at least one addressable software function 24, 26, 28 of the at least one guest application 14, 16, 18 is utilized by the host application 20 based on a configuration 22, as indicated in step 520.

Next, a position at which the at least one software function 24, 26, 28 is used on a display unit 30 is specified as part of the configuration 22, as indicated in step 530.

At least one software object is now defined as part of the configuration 22, as indicated in step 540.

Next, the software object is linked to an addressable software function 24, 26, 28 of the at least one guest application 14, 16, 18 as part of the definition of the at least one software object, as indicated in step 550.

Next, the software function 24, 26, 28 is called-up as part of a processing of the configuration 22 by the host application 20 such that an output of the software function 24, 26, 28 occurs on the display unit 30, as indicated in step 560. In accordance with the invention, the display unit 30 comprises a display unit 30 actuated by the host application 20.

Thus, while there have been shown, described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-5. (canceled)

6. A method for operating a computer system upon which at least one software application functioning as host application and at least one software application functioning as a guest application are executed, the method comprising:
offering at least one addressable software function by at least guest application;
utilizing, by the host application, at least one addressable software function of the at least one guest application based on a configuration;
specifying a position at which the at least one software function is utilized on a display unit as part of the configuration;
defining at least one software object as part of the configuration;
linking the software object to an addressable software function of the at least one guest application as part of the definition of the at least one software object; and
calling-up the software function as part of a processing of the configuration by the host application such that an output of the software function occurs on the display unit;
wherein the display unit comprises a display unit actuated by the host application.

7. The method as claimed in claim 6, wherein at least a first and a second software application functioning as the at least one guest application each execute on the computer system;
wherein at least two guest applications each offer at least one addressable software function;
wherein the host application offers at least one addressable software function of each guest application of the at least two guest applications based on the configuration;
wherein a position of the use of the at least two software functions on a display unit is specified as part of the configuration; and
wherein a data exchange occurs between the at least two software functions via the host application (20).

8. The method as claimed in claim 6, wherein the host application loads a configuration and utilizes said configuration until another configuration is loaded.

9. The method as claimed in claim 7, wherein the host application loads a configuration and utilizes said configuration until another configuration is loaded.

10. A computer program comprising program code instructions, which implements the method of claim 6, when the computer program is executed on a computer.

11. A computer system comprising:
at least one computer having a processing unit and a memory;
wherein the at least one computer into which a computer program functioning as a host application is loaded which, when executed by the processing unit during operation of the computer, causes:
an offer of at least one addressable software function by at least guest application;
a utilization, by the host application, of at least one addressable software function of the at least one guest application based on a configuration;
a specification of a position at which the at least one software function is utilized on a display unit as part of the configuration;
a definition of at least one software object as part of the configuration;
a link of the software object to an addressable software function of the at least one guest application as part of the definition of the at least one software object; and
a call-up of the software function as part of a processing of the configuration by the host application such that an output of the software function occurs on the display unit; and
wherein the display unit comprises a display unit actuated by the host application.
